(19) United States
(12) Patent Application Publication
(10) Pub. No.: US 2018/0251172 A1
(43) Pub. Date: Sep. 6, 2018

(54) Upcycled Vehicle

(71) Applicants: David R. Hall, Provo, UT (US); Stephen R. Hall, Draper, UT (US); Jedediah Knight, Provo, UT (US)

(72) Inventors: David R. Hall, Provo, UT (US); Stephen R. Hall, Draper, UT (US); Jedediah Knight, Provo, UT (US)

(21) Appl. No.: 15/446,527

(22) Filed: Mar. 1, 2017

(51) Int. Cl. B62D 65/00; B62D 21/11; G06Q 10/00; G06Q 30/06; G06K 19/06

(52) U.S. Cl. CPC B62D 65/00; B62D 21/11; G06Q 10/20; G06Q 10/30; B60Y 2200/92; G06K 19/06028; G06K 19/06037; B60Y 2200/91; G06Q 30/0645

(57) ABSTRACT

Upcycled vehicle embodiments and methods of constructing and/or leasing an upcycled vehicle are described herein. A method of leasing an upcycled vehicle may include providing an upcycled vehicle, providing a label on the vehicle that indicates the vehicle is “upcycled,” and leasing the vehicle to a lessee. The upcycled vehicle may include one or more used engine components installed on a new chassis. The chassis may be assembled before selection of the engine, and modified after the engine is selected. The label may indicate to a consumer or other observer of the vehicle that the vehicle includes used engine components installed in a chassis constructed of new materials. The lease may last for a fixed term, the term based on a period of time, a fixed number of miles, or a combination thereof. The vehicle may be received back by the lessor at the end of the lease.

### CROSS-REFERENCES

This application refers to, and incorporates the entirety of, U.S. Pat. No. 8,398,159 to Stephen Hall (herein “Hall”) entitled “Frame Members with Tab and Slot Connections.” Those portions not expressly incorporated are incorporated herein by reference.

### TECHNICAL FIELD

This invention relates generally to the field of vehicles and more specifically to manufacturing and leasing vehicles.

### BACKGROUND

As demand for natural resources increases, efforts have been made to reuse and recycle materials to increase sustainability and efficiency. Despite this recognition and the efforts in that direction, many industries still face barriers to utilizing recycled materials. Such barriers may be enforced by consumers that have real or perceived concerns, and some barriers may be codified as law. One such industry subject to both consumer and legal barriers is the automotive industry. In particular, there is a legal and perceptual bifurcation between new and used vehicles. Because automobiles are assemblies of a myriad of diverse parts with an equal myriad of service lives, the bifurcation between new and used results in significant inefficiency, and may be unsustainable. Thus, solutions are needed to address this inefficiency.

### SUMMARY OF THE INVENTION

Vehicle embodiments and methods are described herein that address at least some of the issues described above in the Background. Such may include methods of constructing and/or leasing an upcycled vehicle, where the adjective “upcycled” may refer to an assembly that incorporates new and used components. For example, a method of leasing an upcycled vehicle may include providing an upcycled vehicle, providing a label on the vehicle that indicates the vehicle is “upcycled,” and leasing the vehicle to a lessee. The upcycled vehicle may include one or more used powertrain components installed on an entirely new chassis. The adjective “used” may refer to one or more components used before assembly of the upcycled vehicle in one or more previously-titled vehicles. The adjective “new” may refer to one or more components that have never been used in a previously-titled vehicle. The label may indicate to a consumer or other observer of the vehicle that the vehicle includes used powertrain components installed in a chassis constructed of new materials. The lease may last for a fixed term, the term based on a period of time, a fixed number of miles, or a combination thereof. The vehicle may be received back by the lessor at the end of the lease, or by a party assigned the rights of the lease by the original lessor. The vehicle may alternatively/additionally be sold to the lessee during or at the end of the lease term.

Embodiments of an upcycled vehicle may include a powertrain installed on a chassis. The powertrain may include one or more used components, a drive train, and/or an engine having a displacement ranging from 30 to 600 cubic inches. The used components may be incorporated into one or more of the drive train and the engine. The chassis may be assembled entirely from new materials, and may include a universal engine cradle. The universal engine cradle may include a first segment and a second segment. The first segment may be integrally formed with the chassis, having a length that accommodates engines having a displacement of 600 cubic inches. The second segment may be detachable from the first segment, and may enclose a forward portion of an engine compartment formed by the universal engine cradle. The universal engine cradle may provide support for, and at least partially enclose, at least a portion of the powertrain. The chassis may be modified after assembly of the chassis and selection of the engine to correspond to the engine selected.

### BRIEF DESCRIPTION OF THE DRAWINGS

A more particular description of the thermoforming apparatus summarized above is made below by reference to specific embodiments. Several embodiments are depicted in drawings included with this application, in which:

FIGS. 1A-D depict various embodiments of vehicles that may be constructed and/or leased according to the methods described herein;

FIG. 2 depicts another embodiment of a vehicle that may be constructed and/or leased according to the methods described herein;

FIGS. 3A-B depict an exploded and an isometric view, respectively, of a tab-and-slot vehicle chassis;

FIG. 4 depicts a vehicle with the body exploded from the chassis;

FIG. 5 depicts another embodiment of an upcycled vehicle that may be constructed and leased according to the methods described herein;

FIG. 6 depicts various vehicle components constructed of new materials;

FIGS. 7A-B depict side views of two embodiments of a tab-and-slot chassis for a vehicle that may be constructed and leased according to the methods described herein;

FIGS. 8A-C depict isometric views of various engine mount embodiments;

FIG. 9 depicts an example of a universal engine cradle with accompanying engine mounts;

FIG. 10 depicts an upcycled vehicle with a new chassis and a used engine mounted in the vehicle;

FIG. 11 depicts various portions of a method of leasing an upcycled vehicle;

FIG. 12 depicts various portions of a method of constructing an upcycled vehicle;

FIG. 13 depicts various portions of a method of sub-leasing an upcycled vehicle;

FIGS. 14A-B depict portions of various methods of providing information to a consumer regarding an upcycled vehicle; and

FIGS. 15A-C depict various examples of labels indicating to a viewer a corresponding vehicle includes used engine components installed in a new chassis.

### DETAILED DESCRIPTION

A detailed description of methods and systems of constructing and leasing an upcycled vehicle is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

The descriptions of the various embodiments include, in some cases, references to elements described with regard to other embodiments. Such references are provided for convenience to the reader, and to provide efficient description and enablement of each embodiment, and are not intended to limit the elements incorporated from other embodiments to only the features described with regard to the other embodiments. Rather, each embodiment is distinct from each other embodiment. Despite this, the described embodiments do not form an exhaustive list of all potential embodiments of the claimed invention; various combinations of the described embodiments are also envisioned, and are inherent from the descriptions of the embodiments below. Additionally, embodiments not described below that meet the limitations of the appended claims are also envisioned, as is recognized by those of skill in the art.

Vehicle embodiments and methods are described herein. Such may include methods of constructing and/or leasing an upcycled vehicle, where the adjective “upcycled” may refer to an assembly that incorporates new and used components. For example, a method of leasing an upcycled vehicle may include providing an upcycled vehicle, providing a label on the vehicle that indicates the vehicle is “upcycled,” and leasing the vehicle to a lessee. The upcycled vehicle may include one or more used powertrain components installed on an entirely new chassis. The adjective “used” may refer to one or more components used before assembly of the upcycled vehicle in one or more previously-titled vehicles. The adjective “new” may refer to one or more components that have never been used in a previously-titled vehicle. The label may indicate to a consumer or other observer of the vehicle that the vehicle includes used powertrain components installed in a chassis constructed of new materials. The lease may last for a fixed term, the term based on a period of time, a fixed number of miles, or a combination thereof. The vehicle may be received back by the lessor at the end of the lease, or by a party assigned the rights of the lease by the original lessor. The vehicle may alternatively/additionally be sold to the lessee during or at the end of the lease term.

The upcycled vehicle may include a lease document that describes various terms for the method of leasing the upcycled vehicle as described herein. The lease document may be provided with the upcycled vehicle to a lessee of the upcycled vehicle from the manufacturer of the vehicle, a lessor of the vehicle, or both. Additionally, the upcycled vehicle may include a consumer-accessible database that stores various information regarding the manufacture of the upcycled vehicle, as described herein. Access to the database may be provided to a consumer with the upcycled vehicle from the manufacturer of the vehicle, a seller of the vehicle, a lessor of the vehicle, or some combination thereof.

Embodiments of an upcycled vehicle may include a powertrain installed on a chassis. The powertrain may include one or more used components and an engine having a displacement ranging from 30 to 600 cubic inches. The chassis may be assembled entirely from new materials, and may include a universal engine cradle. The universal engine cradle may include a first segment and a second segment. The first segment may be integrally formed with the chassis, having a length that accommodates engines having a displacement of 600 cubic inches. The second segment may be detachable from the first segment, and may enclose a forward portion of an engine compartment formed by the universal engine cradle. The universal engine cradle may provide support for, and at least partially enclose, at least a portion of the powertrain. The chassis may be modified after assembly of the chassis and selection of the engine to correspond to the engine selected.

The upcycled vehicle may be provided in any of a variety of ways. For example, the upcycled vehicle may be manufactured and/or assembled by the lessor. The lessor may purchase the vehicle from a manufacturer, either assembled or unassembled. The lessor may purchase non-engine components, such as the vehicle chassis, body, passenger compartment interior, fuel system, suspension, axels and wheels, from a manufacturer, and may purchase engine and/or drive-train components from a used parts dealer. Some engine components may be purchased new from a manufacturer and assembled with used components purchased from a used parts dealer. For example, a used transmission may be installed in a vehicle with otherwise new parts.

Various types of vehicles may be constructed and/or leased according to the methods/systems described herein. One such vehicle includes a three-wheeled roadster, various views and embodiments of which are depicted in the FIGs. Despite this, those of skill in the art recognize the general applicability of the methods/systems described herein to a variety of vehicles. Thus, as used herein, “vehicle” may refer, generally, to any of a variety of inanimate passenger or cargo carriers, including landcraft, watercraft, aircraft, and combinations thereof. Examples include automobiles, all-terrain vehicles, amphibious vehicles, buses, trucks, cars, rickshaws, bicycles, motorcycles, cable cars, sleds, golf carts, drones, handcars, hovercraft, land yachts, locomotives, maglevs, minibuses, minivans, monorails, monowheels, mopeds, omni directional vehicles, quadracycles, rocket sleds, rovers, sea tractors, ground effect vehicles, boats, ships, catamarans, canoes, hydrofoils, jet skis, kayaks, ferries, airplanes, helicopters, autogyros, balloons, gliders, ornithopters, pedalos, powered parachutes, and rockets, among others.

The vehicle may include any of a variety of mechanisms for travelling across and/or through surfaces, such as wheels, skis, tracks, skids, hulls, and airfoils. In wheeled embodiments, the vehicle may include any of a variety of powertrains, including front-wheel drive, rear-wheel drive, three-wheel drive, four-wheel drive, or combinations thereof. For example, the vehicle may incorporate electronics that switch the powertrain between front-wheel drive and three-wheel drive, or between rear-wheel drive and four-wheel drive. The vehicle may include any of a variety of mechanisms for accessing the vehicle, such as doors, windows, hatches, and permanent openings. In various embodiments, the vehicle may include a chassis on which various vehicle components are mounted. The vehicle may also, in some embodiments, include components such as body panels, an engine or motor, a transmission, an electrical system, one or more batteries, a heating and/or cooling system, navigational systems, and a fuel system, among others. Various vehicle components may be comprised of any of a variety of materials and material combinations, such as metal, carbon, plastic, rubber, leather, glass and composites.

As described above, the adjective “used” may refer to components used in another, previously-titled vehicle prior to assembly of the upcycled vehicle. Such components may have been used in a different type of vehicle than the upcycled vehicle, or in the same model as the upcycled vehicle. The previously-titled vehicle and the upcycled vehicle may differ in classification, type, model, year, and/or trim level. For example, in one embodiment, the previously-titled vehicle may include a Toyota Prius and the upcycled vehicle may include a Vanderhall Venice (a three-wheeled roadster manufactured by Vanderhall Motor Works, Inc.). In another embodiment, the previously-titled vehicle may include a wheeled automobile and the upcycled vehicle may include a boat. Used parts may also/alternatively be incorporated from a variety of previously-titled vehicles, either of the same classification, type, model, year and/or trim level, or different.

As described above, the adjective “new” may refer to components that have never been used in another, previously-titled vehicle. Such components may be formed of new materials, such that the materials may be formed into the components after being procured from their natural source or synthesized, and formed for manufacturing. However, in some embodiments, new components may be formed of one or more recycled materials. As used herein, “recycled” refers to materials that have been previously formed and utilized, and that have been reformed and repurposed such that the previous form and use is indiscernible from the present form and use. For example, in some embodiments, the chassis may be formed of recycled steel that was previously utilized as a part of the structure of a building. In some embodiments, new components may be formed of newly formed and recycled materials.

As used herein, the word “universal” refers to “many, but not necessarily all.” Thus, the phrase “universal engine cradle” refers to an engine cradle designed to accommodate many different, but not necessarily all, engine designs.

Engine components may include components of any of a variety of engine types, including internal combustion engines, electric motors, or hybrid internal combustion-electric motors. Engine components may also include components of any of a variety of vehicle systems, including powertrain, heating/cooling, steering, and power. For example, some engine components may include an engine block, a manifold, a camshaft, pistons, a cylinder head, a crankshaft, a starter motor, a valve cover, a transmission, a flywheel, a differential, a gearbox, a transfer case or combinations thereof. The previous list is provided as an example of engine components, and is not intended to be a comprehensive list. Other engine components not listed are also included.

The chassis may include any of a variety of base structures for the vehicle, including a ladder frame, a unibody frame, a backbone tube frame, an X-frame, a perimeter frame a platform frame, a space frame, a subframe, or combinations thereof. The chassis may be formed of any of a variety of materials, including aluminum, steel, carbon, other metal alloys, and/or combinations thereof. The chassis may incorporate various rail designs, such as c-shape, hat, boxed, tubular, planar, and/or combinations thereof. The chassis may include space for various segments of the vehicle, including a passenger and/or cargo compartment and a universal engine cradle. The chassis may incorporate a front-universal engine cradle, a front-mid-universal engine cradle, a rear-mid-universal engine cradle, or a rear-universal engine cradle.

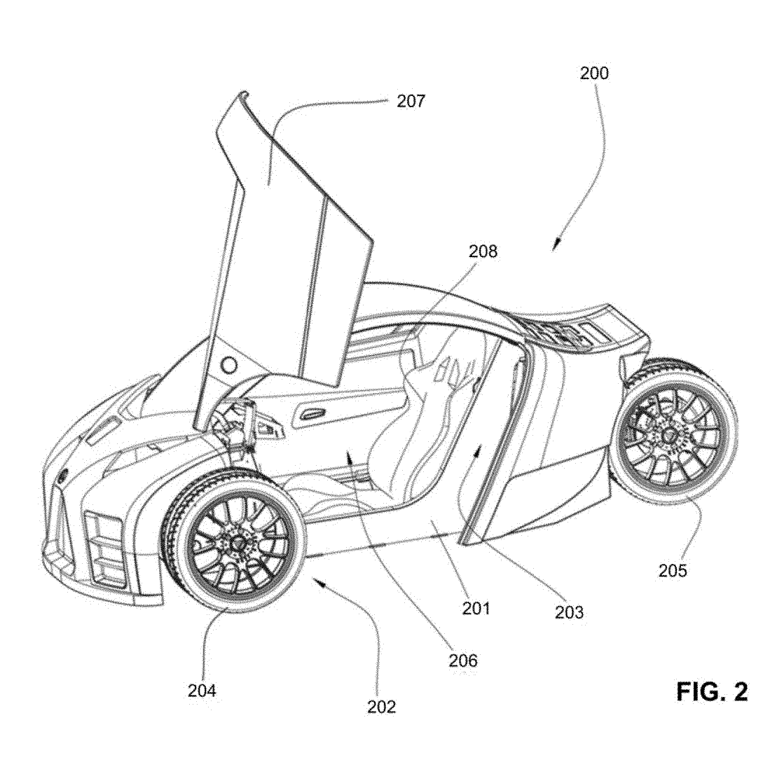

Assembling the chassis may include any of a variety of methods. The particular method employed may depend on the desired structure of the chassis. In one embodiment, assembling the chassis may include aligning transverse and longitudinal support beams in a jig and welding the transverse and longitudinal support beams together. In another embodiment, assembling the chassis may include cutting one or more forms out of a sheet of, for example, aluminum, heating the forms, and bending the forms. In yet another embodiment, at least two side plates may be interlocked with a bottom plate and a vertically loaded plate. The bottom plate and the vertically loaded plate may be non-parallel. The side plates may support the bottom plate and the vertically loaded plate through a plurality of tab and slot connections. The plurality of tab and slot connections may be welded in place. Such a method is an example of tab and slot construction. An example frame that results from such a process is described in Hall in at least FIGS. 2-10d and col. 3 line 36 through col. 7 line 47. Though reference is made to specific portions of Hall, the entirety of Hall is incorporated herein by reference. Some portions of Hall have been duplicated herein for convenience.

The universal engine cradle may be an intermediate structure in the vehicle assembly process that allows for flexibility in the engine selection process. The universal engine cradle may allow for flexibility in engine size, such as, for wheeled automobiles, ranging from 30- to 600-cubic inch displacements, and may allow for flexibility in engine orientation, either transverse or longitudinal. Various embodiments may include engines having displacements ranging from 30 to 600 cubic inches, 30 to 90 cubic inches, 90 to 120 cubic inches, 120 to 150 cubic inches, 150 to 180 cubic inches, 180 to 210 cubic inches, 210 to 240 cubic inches, 240 to 270 cubic inches, 270 to 300 cubic inches, 300 to 330 cubic inches, 330 to 360 cubic inches, 360 to 390 cubic inches, 390 to 420 cubic inches, 420 to 450 cubic inches, 450 to 480 cubic inches, 480 to 510 cubic inches, 510 to 540 cubic inches, 540 to 570 cubic inches, 570 to 600 cubic inches, or combinations thereof.

A few features may be incorporated that enable such flexibility. The universal engine cradle may include two segments: a first segment integral with the chassis, and a second segment that is detachable from the first segment and/or the rest of the chassis. The first segment may be elongated to accommodate engines having displacements of 600 cubic inches. The first segment may include one or more surfaces to which engine mounts may be coupled. Such surfaces may extend along the universal engine cradle on outside edges of the universal engine cradle and/or along inner surfaces of the universal engine cradle. The universal engine cradle may include an open end where the second segment is detachable and a firewall having an opening that may accommodate a transmission in longitudinal embodiments. Slots may be disposed along the opening and along a portion of the chassis extending into a passenger compartment. The slots may correspond to shielding; the slots around the opening may correspond to tabs in shielding placed over the opening in transverse embodiments; the slots along the portion of the chassis extending into the passenger compartment may correspond to tabs on shielding that surrounds the transmission in longitudinal embodiments.

Openings may be formed along sides of the universal engine cradle to accommodate wheel axels and surfaces for mounting suspension components. The openings may extend along an entire length of the universal engine cradle to accommodate different axel positions based on different engine sizes. Once an engine size is selected, pivot mechanisms may be welded to the universal engine cradle within one or more of the openings. The pivot mechanisms may correspond to various suspension components, such as one or more control arms. The second segment may be bolted or welded to the first segment to form an engine compartment. The second segment may also provide support for one or more engine components or systems, such as an engine cooling system.

The mounting surfaces may be planar. Once an engine is selected and engine mounts are identified, bolt holes may be bored into the mounting surfaces corresponding to the positions of the engine mounts. For example, a transverse engine may include three engine mounts: a first mount disposed over the engine along a passenger-side of the chassis, a second mount disposed over the engine along a driver-side of the chassis, and a third mount disposed beneath the engine between the engine and the firewall. A longitudinal engine may include a first mount disposed beneath the engine along a passenger-side of the chassis, a second mount disposed beneath the engine along a driver-side of the chassis, and a third mount disposed between the chassis and the transmission over the transmission. In some embodiments, a firewall between the engine compartment and the passenger compartment may include a mounting surface, such as for the third mount.

Once an engine is selected and the mounts are identified, portions of the universal engine cradle may be pared to shrink the size of the universal engine cradle to accommodate and/or correspond to the size of the selected engine. The second segment may be coupled to the first segment before or after the universal engine cradle is pared. In one embodiment, tabs are formed in the pared edges. The second segment may include slots corresponding to the tabs formed in the pared edges, and the tabs may be welded in the slots. Alternatively, the second segment may include tabs corresponding to the tabs in the pared edges, and the corresponding tabs may be bolted together.

As described above, the flexibility of the universal engine cradle may accommodate a variety of engine designs. Such designs may include internal combustion engine designs, electric motor designs, hybrid internal combustion-electric motor designs, front-engine designs, front-mid-engine designs, rear-engine designs, rear-mid-engine designs, mid-engine designs, front-wheel drive designs, rear-wheel drive designs, all-wheel drive designs, longitudinal designs, transverse designs, or combinations thereof.

Selecting an engine may include any of a variety of methods and/or systems. In one embodiment, selecting an engine includes identifying a vehicle that can no longer be driven, identifying whether the engine is operable, and identifying whether any components of the engine have been damaged and must be replaced with new components or components from another vehicle. The manufacturer of the vehicle may perform these actions directly, or may contract with a used parts dealer to identify and procure an engine. Once the engine is selected, the universal engine cradle and/or chassis may be modified as described above to accommodate the selected engine.

The engine may be installed in the universal engine cradle once the engine is selected. This may be accomplished in a variety of ways. For example, engine mounts may be coupled to the engine, and the engine may be suspended over the universal engine cradle. The engine may be lowered into the universal engine cradle so that the engine mounts contact the mounting surfaces. The universal engine cradle may be marked corresponding to the engine mounts, and the engine may be lifted. Bolt holes may be formed in the mounting surfaces, such as by drilling or laser-cutting. The engine may be lowered back into the universal engine cradle, and the mounts may be bolted to the mounting surfaces. The first segment may be pared, and the second segment may be coupled to the first segment.

The label may be provided on the upcycled vehicle in a variety of ways. In one embodiment, the label may be placed on an inside surface of a door or door jamb. In another embodiment, the label may be placed on an exterior surface, such as a body panel, of the vehicle. The label may be placed on an interior surface of the vehicle, such as on an underside of a hood or trunk, or on an interior wall panel of the vehicle. In some embodiments, the label may be placed on a window or windshield of the vehicle.

The label may be embodied in any of a variety of ways, such as a sticker, decal or three-dimensional emblem. The label may have one or more words and/or one or more pictographs that may indicate the vehicle to which the label is attached is upcycled. One or more words may be represented pictographically and/or stylistically to indicate the vehicle is upcycled. For example, the label may include one or more of the words “upcycled,” “newcycled,” and “recycled.” The label may additionally or alternatively include a machine-readable optical code. The optical code may include one or more of an alpha-numeric code and a non-alpha-numeric code such as a one-dimensional barcode, a two-dimensional barcode, a three-dimensional barcode, a color-code, or a combination thereof. One such embodiment may include a two-dimensional barcode that is additionally color-coded with 5 colors: black, white, red, green and blue. Alternatively or additionally, the optical code may include a previously-titled vehicle year indicator, a previously-titled vehicle make indicator, a previously-titled vehicle model indicator, a previously-titled vehicle component indicator, or a combination thereof. For example, the optical code may include a three-dimensional barcode that, when optically read by a machine such as a smartphone or tablet, may indicate the year, make, model and component or components of a previously-titled vehicle from which the components were sourced. The optical code may double as an interior and/or exterior design that may provide both utilitarian and aesthetic functions.

As described above, the label may indicate to a viewer of the label that the vehicle is upcycled, and may further indicate information about used parts incorporated into the vehicle. For example, the label may include a three-dimensional emblem with a pictographic and/or stylistic design of a word, such as “newcycled.” The emblem may be placed on an exterior of the vehicle. Directly below and immediately adjacent to the emblem, a sticker may be placed on the vehicle and/or emblem that includes a series of alpha-numeric symbols, such as “2011.Toyota.Prius.AllEngTrans.” This set of symbols may indicate to a reader that the entire engine and transmission of the upcycled vehicle was sourced from a 2011 Toyota Prius. The label may also include a two-dimensional barcode that, when scanned with a smartphone and/or tablet, displays to the reader text explaining the previously-titled vehicle's history. Such history may include, for example, “November 2010: registered in UT; mileage: 57. July 2013: registered in CO; mileage: 32,456. August 2016: totaled in CO; side-impact; no drive-train damage; mileage: 63,845. December 2016: replaced belts, hoses, motor mounts; mileage: 63,845. January 2017: installed in 2017 [Make] [Model].”

Once the upcycled vehicle is constructed, it may be leased. The lease may include various stipulations, such as a fixed monthly payment, a fixed term based on a period of time and/or a fixed number of miles, and various surcharges, amongst others. The lease may include an obligation on the lessor to provide a minimum amount of fuel for the upcycled vehicle during the term of the lease, a maximum amount of fuel for the upcycled vehicle during the term of the lease, or a combination thereof. For example, the lease may stipulate that the lessor will provide a maximum of one “fill-up” per week during the term of the lease, where a “fill-up” includes adding fuel to the gas tank until the gas tank is full, regardless of how much fuel is already in the tank. The lease may include an obligation to provide maintenance for the upcycled vehicle during the term of the lease, such as by performing oil changes, replacing batteries, replacing spark plugs, inspecting and replacing belts and hoses, inspecting and repairing the suspension, replacing and repairing the tires, and inspecting and repairing the powertrain, amongst others. The lease may also include an obligation on the lessee to present the upcycled vehicle to the lessor for maintenance. The lease may include an obligation on the lessor to provide insurance for the upcycled vehicle during the term of the lease.

The fixed term of the lease may include a fixed period of time, a fixed number of miles, or a combination thereof. For example, the lease term may extend for 6 months and have a maximum mileage of 10,000 miles, with a surcharge for extra mileage. These specific terms may be particularly advantageous for a vehicle that is typically only operated during specific times of the year and/or specific seasons, such as a snowmobile, a motorcycle, or a three-wheeled roadster.

The methods of constructing and/or leasing the upcycled vehicle may include creating an electronic, consumer-accessible database and storing information about the upcycled in the database. The database may include identifying characteristics of the engine, such as a size and orientation of the engine and a type of transmission, mileage of the engine, one or more reasons the engine was removed from the previously-titled vehicle, how the engine was selected, from where the engine was selected, repairs made to the engine before the installation, or a combination of such information. A consumer and/or individual who desires such information about the upcycled vehicle may, for example, scan a barcode on the label with a smartphone or tablet device. The barcode may direct the device to retrieve the information from the database corresponding to the specific upcycled vehicle. This may be particularly useful for a consumer seeking to lease the vehicle. The information may put the consumer in a position to select an upcycled-vehicle he or she is most comfortable with, having all the used-component history available to make the decision. The database may be stored on a remote, cloud-based server connected to the internet. The consumer's device may include a hardware optical device, such as a camera and/or laser scanner, that scans the barcode. The device may also/alternatively include a software application that processes the data encoded in the barcode. The data may include an address for the database and an upcycled vehicle identifier. The database may store information about the upcycled vehicle such that the information is correlated with the upcycled vehicle identifier. The software application may include instructions to retrieve the information correlated with the upcycled vehicle identifier. The software application may include instructions for displaying the retrieved information to the consumer.

The method of leasing the upcycled vehicle may include procuring an engine history document and providing the document to the lessee. The document may convey such information to the lessee as identifying characteristics of the engine, such as a size and orientation of the engine and a type of transmission, mileage of the engine, one or more reasons the engine was removed from the previously-titled vehicle, how the engine was selected, from where the engine was selected, repairs made to the engine before the installation, or a combination of such information. This document may, in some embodiments, be sourced from the database described above. The information may be provided to the lessee on a tangible paper document, electronically, or both.

In various cases, the lease may include permission granted to the lessee to sub-lease the upcycled vehicle during the term of the lease. This may be advantageous, for example, between a manufacturer and a company that provides short-term rental vehicles to consumers. A method of sub-leasing the vehicle may include leasing an upcycled vehicle from a manufacturer of the vehicle, where the vehicle may be constructed as described above, and sub-leasing the vehicle to a sub-lessee for a fixed term. The fixed term may be based on a period of time, a fixed number of miles, or a combination thereof. The vehicle may be acquired from the manufacturer with a label indicating the vehicle includes engine components used in a previously-titled vehicle installed on a chassis constructed of new materials, or the sub-lessor may provide the label on the vehicle.

The FIGs. described below depict various embodiments of upcycled vehicles that may be constructed and/or leased according to the methods and/or systems described herein. Example steps in methods of constructing and/or leasing an upcycled vehicle are also depicted and described. The depicted embodiments should be understood to be representative of the general methods and systems described above, and representative of the general types of upcycled vehicles that may be used in the methods and systems. Not all steps in constructing and/or leasing an upcycled vehicle are listed, but may be inferred from practices known in the technical field.

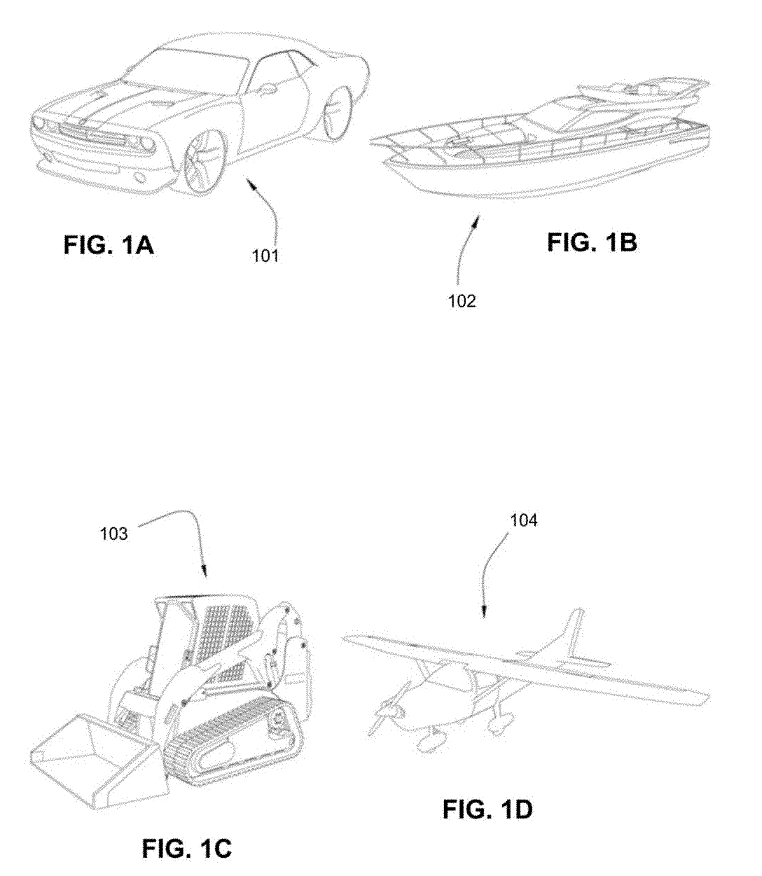

FIGS. 1A-D depict various embodiments of vehicles that may be constructed and/or leased according to the methods described herein. FIG. 1A depicts a wheeled passenger automobile 101. FIG. 1B depicts a boat 102. FIG. 1C depicts a track utility vehicle 103. FIG. 1D depicts a propeller-driven aircraft 104.

FIG. 2 depicts another embodiment of a vehicle that may be constructed and/or leased according to the methods described herein. The vehicle 200 may comprise a vehicle chassis 201 that comprises a front portion 202 and a rear portion 203. Two steerable front wheels 204 may connect to the front portion and a single rear wheel 205 may connect to the rear portion. The vehicle may comprise an enclosed passenger compartment 206. A door 207 may be disposed intermediate the front and rear portions enabling entrance into the vehicle. A seat 208 may be placed within the vehicle on the vehicle chassis.

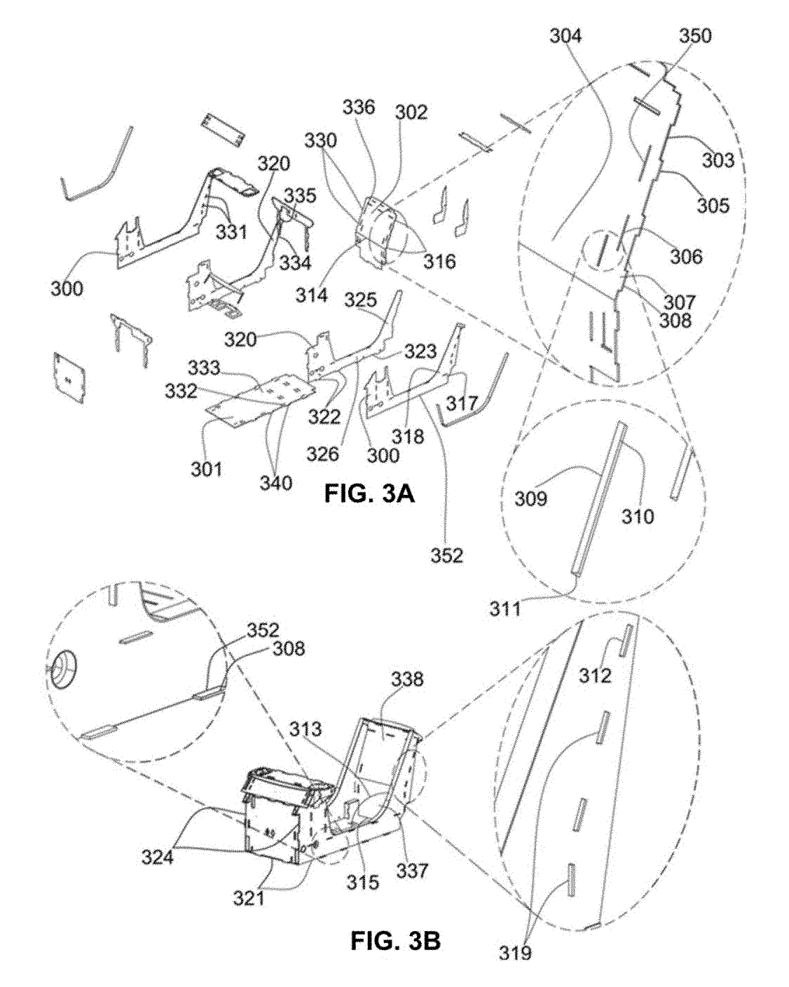

FIGS. 3A-B depict an exploded and an isometric view, respectively, of a tab-and-slot vehicle chassis. The chassis includes two side plates 300, two internal side plates 320, a bottom plate 301 and a vertically loaded plate member 302. The bottom and vertically loaded plate members are non-parallel. The plates include tabs 305 and slots 306. The slots form gaps in the plates. The tabs are located on edges 303 of the plates, extending from the edge. The vertically loaded plate member is configured to sustain a vertical load. The load may be a weight of various frame components. To sustain the load, at least a portion of the vertically loaded plate may form an obtuse angle 313 with the bottom plate member. The obtuse angle may allow the vertically loaded member to be more vertical than the bottom plate member. Making the vertically loaded member substantially vertical may help the vehicle frame to support vertical loads.

The vertically loaded member may be bent along its width 314. This may allow the bottom plate member and vertically loaded member to be substantially perpendicular at a connection 315. The connection 315 may be strongest when nearly perpendicular. The vertically loaded member may then bend such that a portion of the vertically loaded member may form the obtuse angle. Bending the vertically loaded member may form non-parallel tabs on the edge of the vertically loaded member.

The slots formed into the vehicle frame members may comprise a variety of geometries. Some slots may be configured to be through slots; these slots form a gap 350 in an entire thickness 311 of the plate members. Some of the slots may be configured to be channel slots 352, which may be formed on the edge of the plate members and be configured to partially surround but not enclose the gap formed by the slot. The non-parallel tabs 316 on the edge of the vertically loaded member may be configured to enter matching non-parallel slots 317 on a face 318 of the side plate member. The non-parallel tabs and slots may form the same obtuse angle with the bottom plate member. The obtuse angle formed between the vertically loaded member and the bottom plate member may also strengthen connections between the side plate members, bottom plate members, and vertically loaded members. Non-parallel connections 319 may resist translation of the frame members in different directions which may hold the frame members more rigidly together, better interlocking them.

The internal side plate member may be attached to the bottom plate member and vertically loaded plate member. The internal side plate member may be configured to stabilize the vehicle frame. The internal side plate member may comprise tabs 322 along edges 325 and slots 323 formed in a face 326 of the member. Tabs may be formed along a bottom edge of the plate that are configured to enter slots 332 formed in a face 333 of the bottom plate member. The bottom plate member may be configured to support the internal side plate member by the slots 333 holding the tabs 322 in place.

The internal side plate member may also comprise tabs 334 along a rear edge 335. The tabs along the rear edge may be configured to enter slots 336 formed in the face of the vertically loaded member. The slots may be formed on a first 337 and second 338 end of the vertically loaded plate member. The rear edge of the internal side plate may be configured to match the face of the vertically loaded member. The rear edge may follow the first end, second end, and bend in the vertically loaded member. The vertically loaded plate member may be configured to support the internal side plate member.

The internal side plate member may be configured to be attached and welded to the bottom plate member and vertically loaded member before the side plate member is attached and welded to the bottom plate member and vertically loaded member. Attaching and welding the internal side plate member first may allow the internal member to be appropriately welded before a proximate adjacent side plate member is assembled and welded.

The internal side plate member's tabs that enter the slots in the vertically loaded member and bottom member may further interlock the frame members. The vertically loaded member further comprises tabs that enter the side plate member and bottom member. The bottom member comprises tabs 340 that enter the side plate member. By inserting the aforementioned members into one another in a pattern as described the chassis members become more interlocked. Interlocking the chassis members in such a manner may increase the ability of the tabs to sustain the weight load of the chassis members through the slots supporting the tabs in different axes. The tabs may comprise a base end 307 and an extending end 308. The base end may be a portion of the tab closest to the frame member. The extending end may extend from the base end. The tabs located on the at least one edge of the at least one of the plate members may be configured to enter the slots formed in at least one face of the plate members. The tab and slot connections 312 may be configured to position the frame members for welding. The connections may have unique designs such that certain tabs 330 must enter mated slots 331. The certain tabs may then be welded to the mated slots, correctly positioning the frame members.

In some embodiments, the plate members may be replaced by other members. The other members may be comprised of bars, rods, booms, crossbars, rails, shafts, and/or slabs. The members may distribute loads, stresses, and strains in a similar manner as the plate members. The members may also be assembled using the tab and slot connections. In some other embodiments, a groove slot may be formed into one of the plate members but be configured to have a back wall; the groove slot may have a depth that is less than the thickness of the plate members.

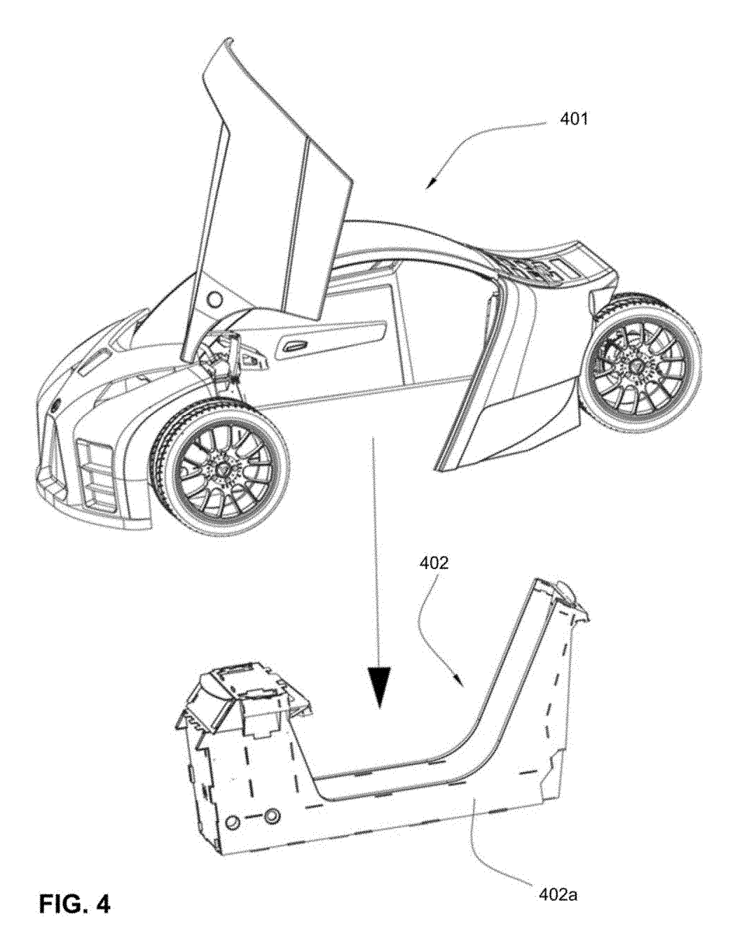

FIG. 4 depicts a vehicle with a body exploded from a chassis. The vehicle includes the body 401 and the chassis 402. The chassis may comprise a plurality of vehicle chassis members 402a. The chassis members may form a motorized trike chassis. The chassis members may be configured to support a vehicle load and support the vehicle during use. The chassis members may comprise other vehicle components attached to the members.

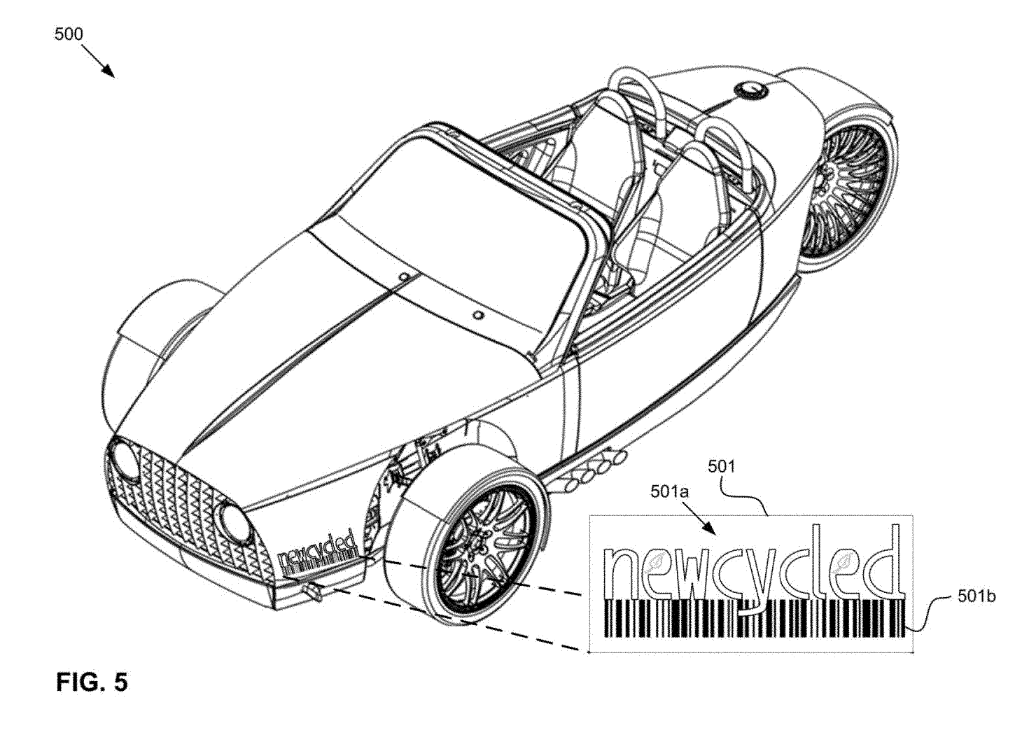

FIG. 5 depicts another embodiment of an upcycled vehicle that may be constructed and leased according to the methods described herein. The vehicle 500 includes a label 501 that indicates to a viewer of the label that the vehicle is constructed of a new chassis and one or more used engine components. The label includes stylized letters 501a that convey this concept, and a stylized barcode 501b. The viewer may scan the barcode with a device having an optical scanner and may obtain further information about the previously used parts from a database on a cloud-based server.

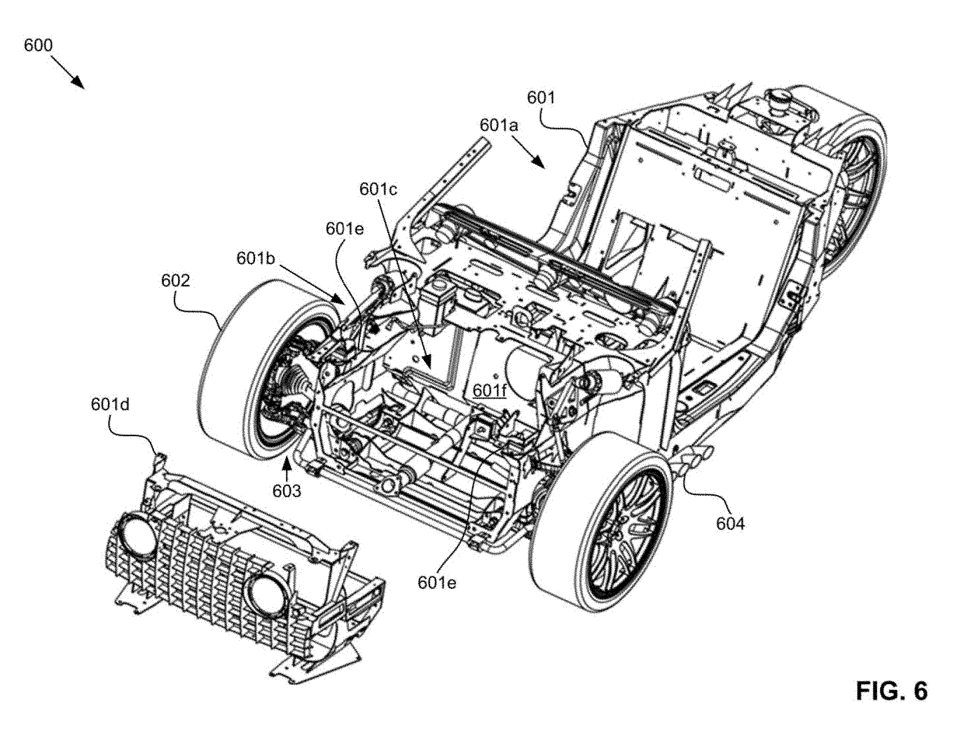

FIG. 6 depicts various vehicle components constructed of new materials. The vehicle 600 includes a chassis 601, wheels and tires 602, suspension and axels 603, and an exhaust system 604. The chassis includes a passenger compartment 601a and a universal engine cradle 601b. The universal engine cradle includes a first segment 601c and a second segment 601d, where the second segment is detachable from the first segment. Despite this, the second segment may be formed of the same materials as the chassis and may provide structural support to various components of the vehicle, such as an engine cooling system. The universal engine cradle includes mounting surfaces 601e on which a variety of used engines may be mounted. The universal engine cradle also includes a firewall 601e with a detachable plate 601f The detachable plate may be removed to allow space for a transmission should a longitudinal engine assembly be selected for installation in the vehicle. Shielding may be added around the transmission and welded to the chassis inside the passenger compartment in such a case.

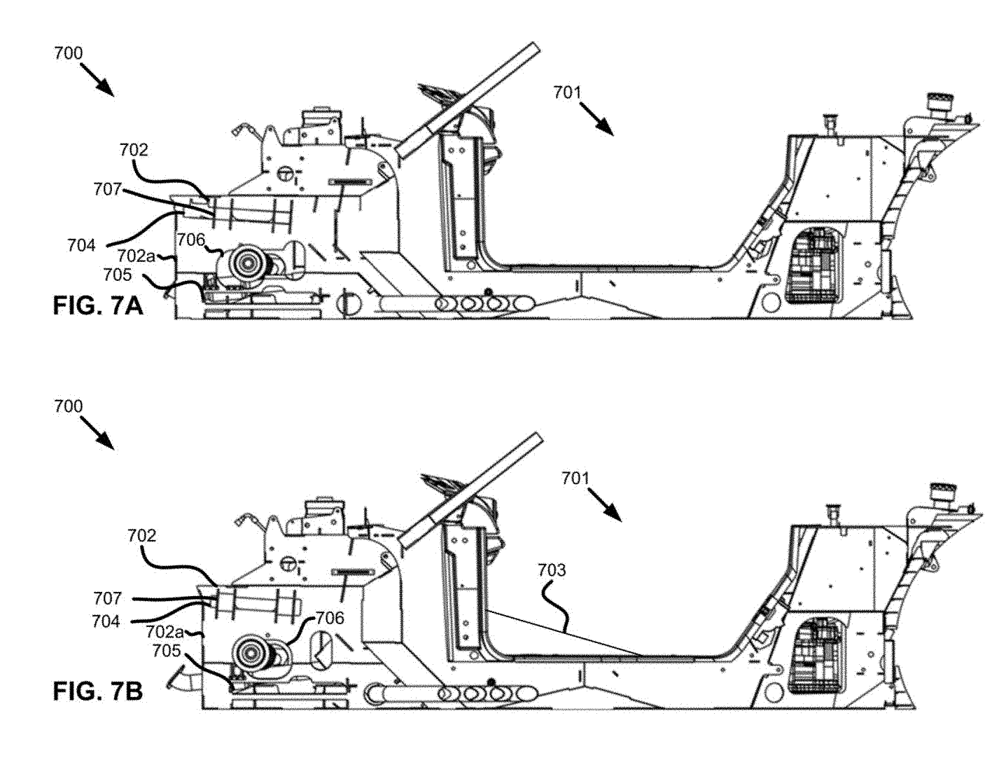

FIGS. 7A-B depict side views of two embodiments of a tab-and-slot chassis for a vehicle that may be constructed and leased according to the methods described herein. The chassis 700 includes a passenger compartment 701 and a segment of a universal engine cradle 702. Not depicted is a second segment that may enclose the universal engine cradle. FIG. 7B also depicts shielding 703 placed over a transmission in cases where a longitudinal engine assembly is selected. FIG. 7A depicts an embodiment where the segment is elongated. Suspension mount slots 704, 705 are also elongated, as well as axel opening 706. After an engine is selected, a front end 702a of the universal engine cradle may be pared back to match the size of the engine selected. Suspension mounts 707 may be placed in the suspension mount slots according to the position of the axels based on the size of the selected engine. The second segment of the universal engine cradle may be connected to the front end of the universal engine cradle after the front end is pared.

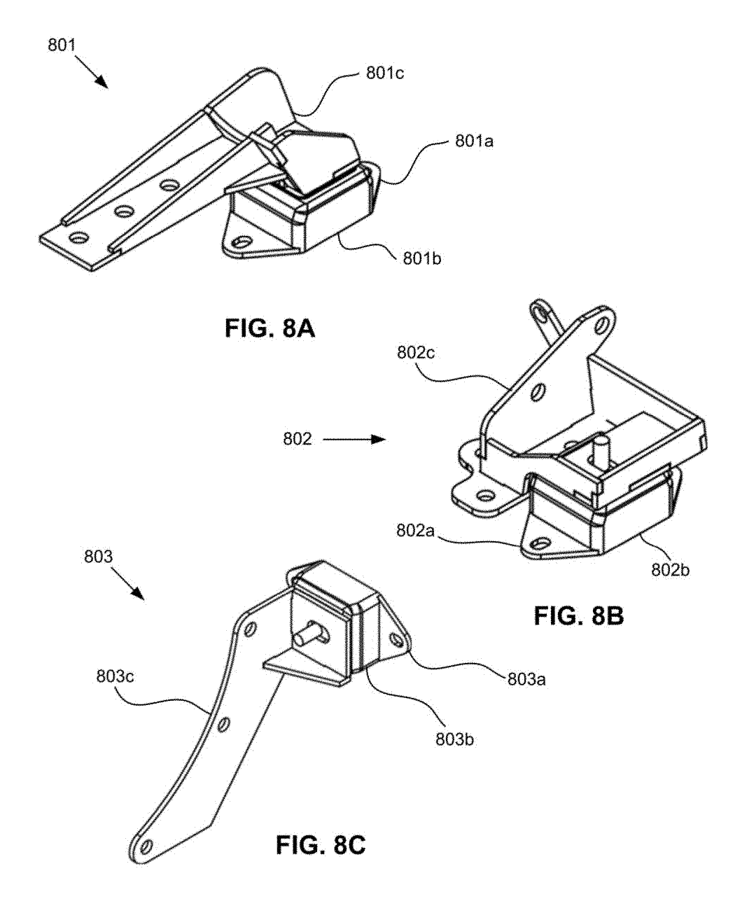

FIGS. 8A-C depict isometric views of various engine mount embodiments. In FIG. 8A, a first engine mount 801 includes a first chassis bracket 801a, a first vibration absorber 801b, and an elongated engine bracket 801c. The elongated engine bracket may extend the mounting surface to accommodate various engine sizes and alignments. In FIG. 8B, a second engine mount 802 includes a second chassis bracket 802a, a second vibration absorber 802b, and a boxed engine bracket 802c. The boxed engine bracket may allow for coupling to engines with mounting bores positioned vertically on, for example, the engine block. In FIG. 8C, a third engine mount 803 includes a third chassis bracket 803a, a third vibration absorber 803b, and a second elongated bracket 803c. The second elongated bracket may allow for a variety of spacings within the universal engine cradle from the firewall to accommodate a variety of engine sizes.

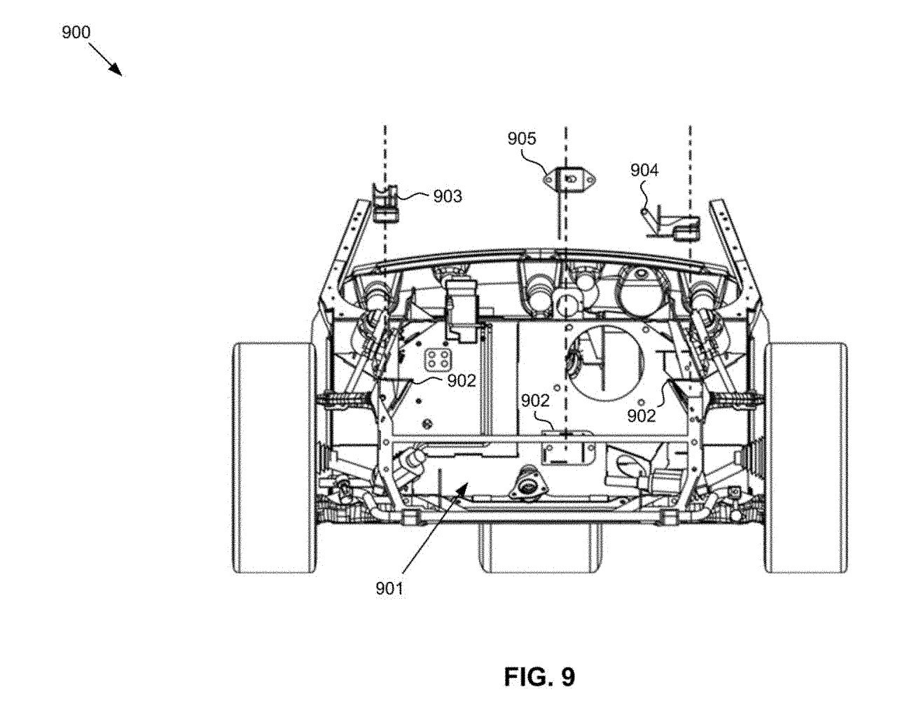

FIG. 9 depicts an example of a universal engine cradle with accompanying engine mounts. A vehicle chassis 900 includes the universal engine cradle 901, mounting surfaces 902, a passenger-side engine mount 903, a driver-side engine mount 904, and a firewall engine mount 905. In the depicted embodiment, the passenger- and driver-side engine mounts are positioned at the same depth. However, the selected engine (not shown) requires mounting further forward on the passenger side than on the driver side. Thus, the passenger-side engine mount includes an elongated bracket, similar to that depicted in FIG. 8A.

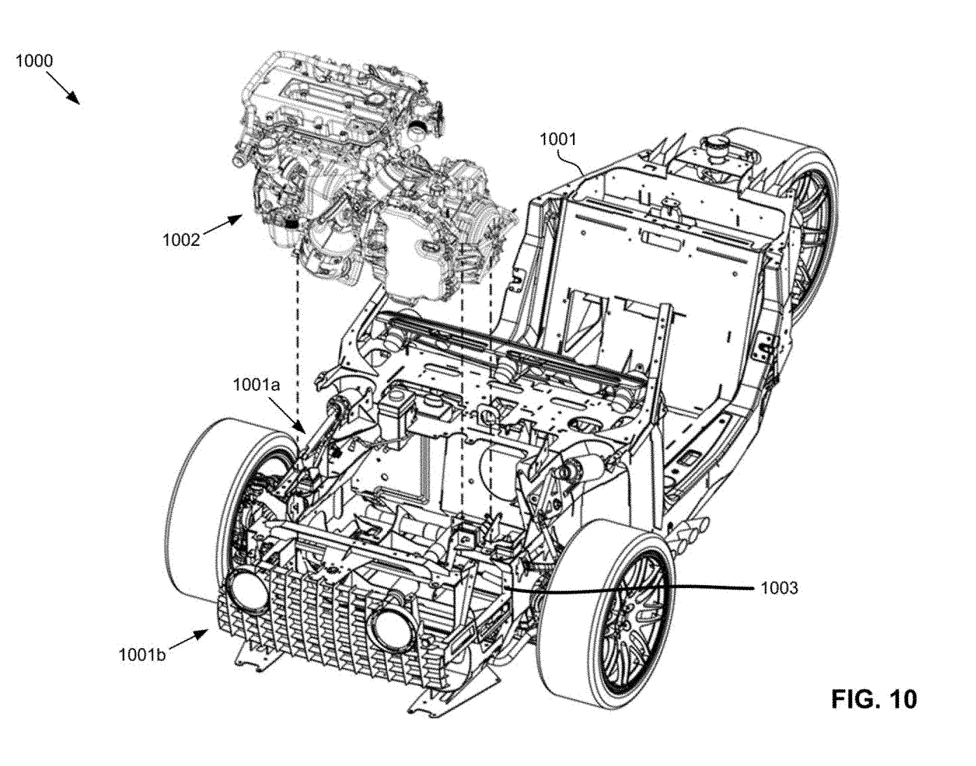

FIG. 10 depicts an upcycled vehicle with a new chassis and a used engine mounted in the vehicle. The vehicle 1000 includes the chassis 1001, which is constructed of new materials, and the engine 1002, which has been used in a previously-titled vehicle. The chassis includes a first segment 1001a and a second segment 1001b. The second segment is coupled to the first segment by bolts 1003, and is detachable. For example, depending on the size and orientation of the engine, it may be advantageous to install the engine before coupling the second segment to the first segment.

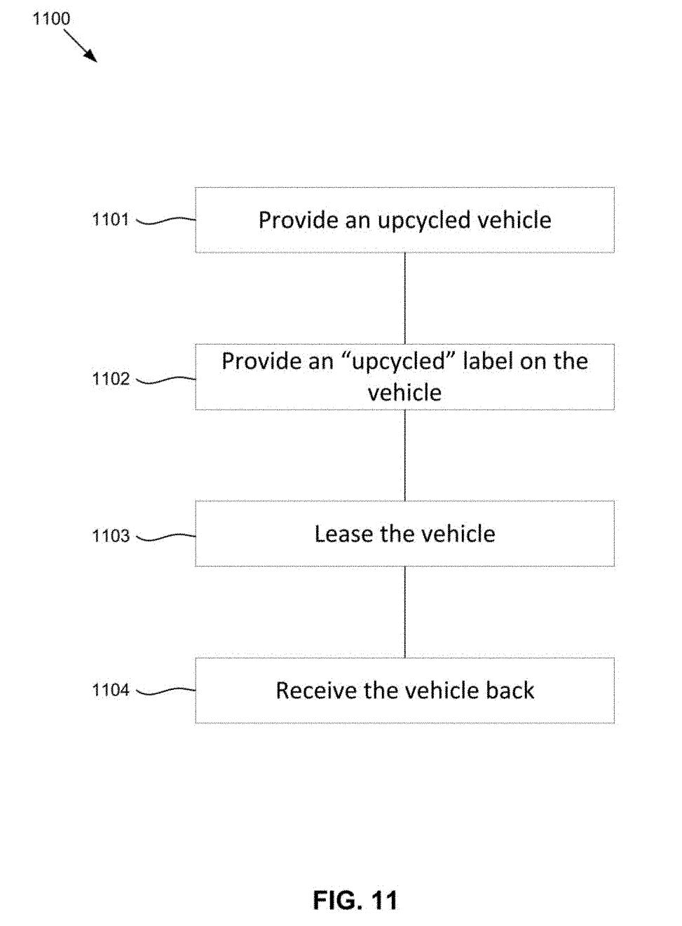

FIG. 11 depicts various portions of a method of leasing an upcycled vehicle. Method 1100 includes, at block 1101, providing an upcycled vehicle. The upcycled vehicle may be constructed by methods including various portions described herein. The resultant vehicle may include any of the embodiments described herein, among others. At block 1102, the method includes providing a label on the vehicle that indicates the vehicle is upcycled. At block 1103, the method includes leasing the vehicle. The lease may include various terms as described herein. At block 1104, the method includes receiving the upcycled vehicle back from the lessee. However, in alternative embodiments, the vehicle may be sold and the lease may be administered by another party. In some embodiments, the vehicle may be sold to the lessee.

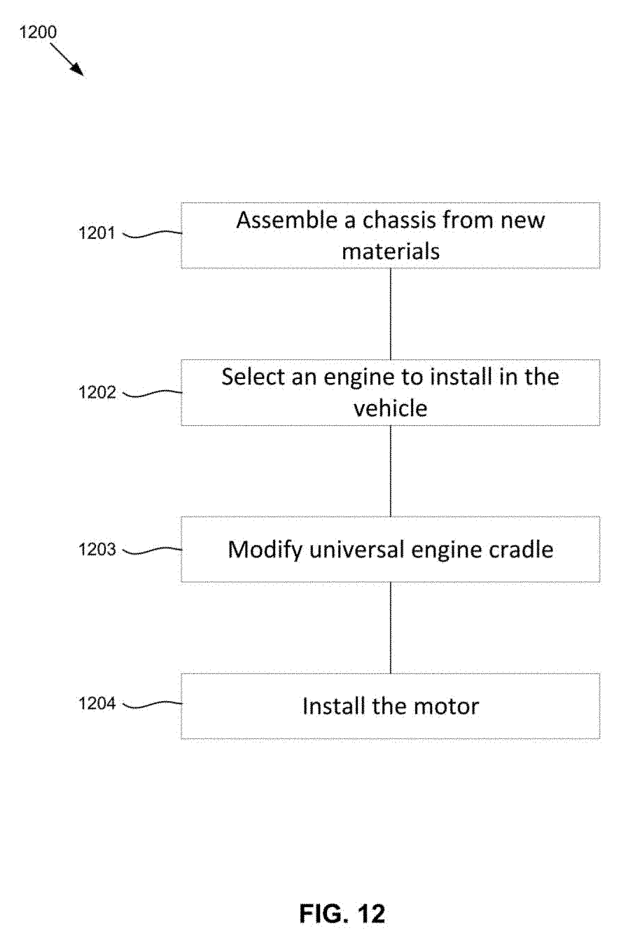

FIG. 12 depicts various portions of a method of constructing an upcycled vehicle. Method 1200 includes, at block 1201, assembling a chassis from new materials. For example, the chassis may be assembled using a tab-and-slot construction method, such as is described above regarding FIGS. 3-4B. The chassis may include a universal engine cradle that may be modified to fit any of a variety of engine designs, sizes, and/or orientations. At block 1202, the method includes selecting an engine to install in the vehicle. The engine may include any of a variety of used components, or may be entirely used. At block 1203, the method includes modifying the universal engine cradle to fit the selected engine. The universal engine cradle may be modified by any of a variety of additive or subtractive methods as described herein (e.g. paring and/or adding shielding), and/or brackets may be modified to mate mounting bores in the engine with the mounting surfaces. At block 1204, the method includes installing the motor in the universal engine cradle by mounting the engine and engine mounts to the mounting surfaces. Such may be done by, for example, bolting or welding the engine mounts to the mounting surfaces and bolting the engine mounts to the engine.

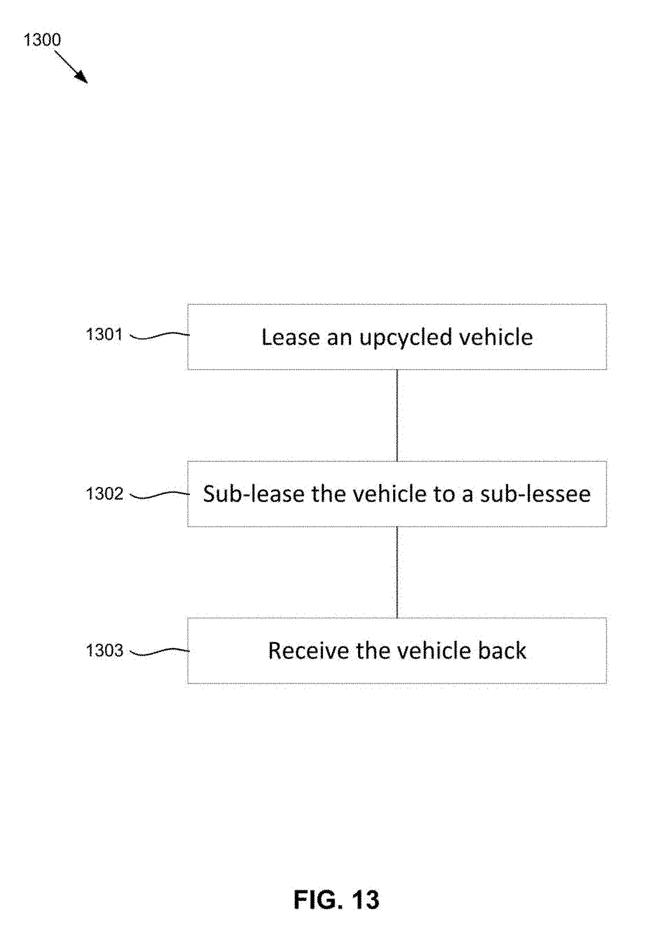

FIG. 13 depicts various portions of a method of sub-leasing an upcycled vehicle. Method 1300 includes, at block 1301, leasing an upcycled vehicle, such as from the manufacturer of the upcycled vehicle. At block 1302, the method includes sub-leasing the vehicle to a sub-lessee. At block 1303, the method includes receiving the vehicle back from the sub-lessee.

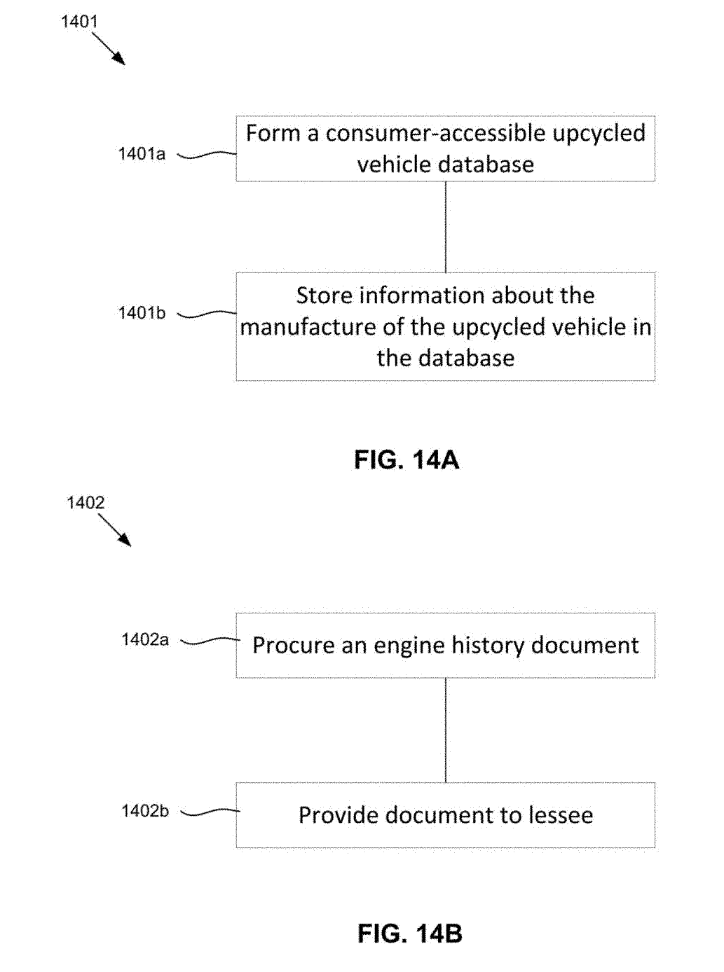

FIGS. 14A-B depict portions of various methods of providing information to a consumer regarding an upcycled vehicle. Method 1401 includes, at block 1401a, forming a consumer-accessible upcycled vehicle database. The database may correlate information about used engine components with a vehicle identifier that may allow a consumer to retrieve such information regarding a desired upcycled vehicle. At block 1401b, the method includes storing information about the manufacture of the upcycled vehicle in the database. Such information may include a previously-titled vehicle year, make, model, a reason the previously-titled vehicle was taken out of service, how the engine was acquired, how many miles were on the previously-titled vehicle when it was taken out of service, or combinations thereof. Method 1402 includes, at block 1402a, procuring an engine history document. The document may include some or all of the information listed above regarding the previously-titled vehicle. At block 1402b, the method includes providing the document to a lessee of the upcycled vehicle.

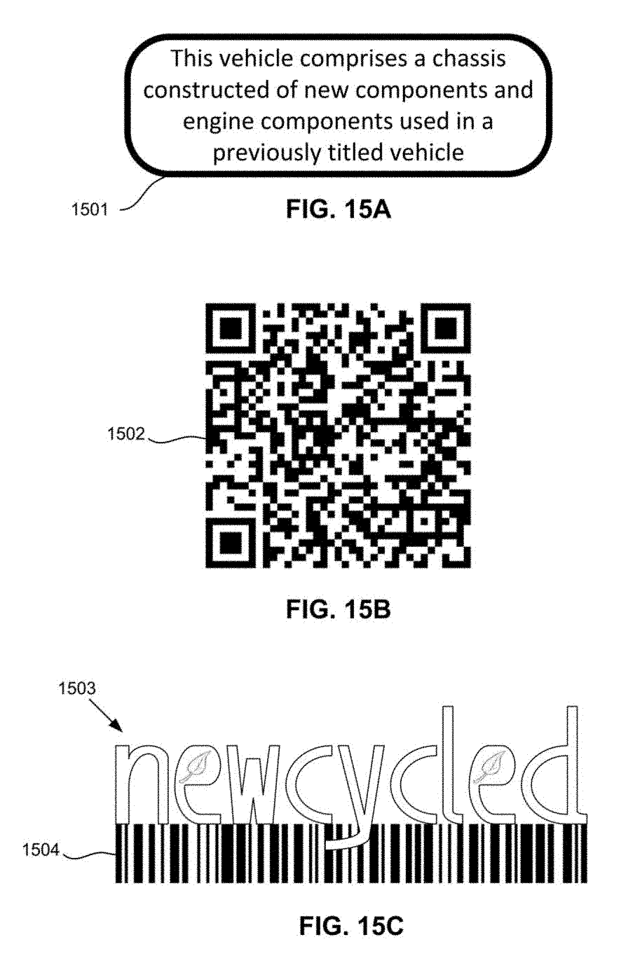

FIGS. 15A-C depict various examples of labels indicating to a viewer a corresponding vehicle includes used engine components installed in a new chassis. FIG. 15A depicts a sticker 1501 providing a statement to the viewer. FIG. 15B depicts a two-dimensional bar code 1502. FIG. 15C depicts stylized alpha-numeric characters 1503 over a one-dimensional bar code 1504. The labels may be placed in any of a variety of positions on/in the upcycled vehicle, such as is described herein.

We claim:

1. An upcycled vehicle, comprising:
a powertrain, comprising:
one or more used components; and
an engine having a displacement ranging from 30 to 600 cubic inches; and
a chassis assembled entirely from new materials, the chassis comprising a universal engine cradle, the universal engine cradle comprising:
a first segment integrally formed with the chassis, the first segment comprising a length that accommodates engines having a displacement of 600 cubic inches;
a second segment detachable from the first segment that encloses a forward portion of an engine compartment formed by the universal engine cradle,
wherein the universal engine cradle provides structural support for, and at least partially encloses, at least a portion of the powertrain, and
wherein the chassis is modified after assembly of the chassis and selection of the engine to correspond to the engine selected.

2. The upcycled vehicle of claim 1, further comprising a label on the vehicle that indicates the vehicle includes one or more used powertrain components installed on a chassis constructed entirely of new materials.

3. The upcycled vehicle of claim 1, further comprising a label on the vehicle that indicates the vehicle includes one or more used powertrain components installed on a chassis constructed entirely of new materials, wherein the label comprises one or more of the words “upcycled,” “newcycled,” and “recycled.”

4. The upcycled vehicle of claim 1, further comprising a label on the vehicle that indicates the vehicle includes one or more used powertrain components installed on a chassis constructed entirely of new materials, wherein the label comprises a machine-readable optical code.

5. The upcycled vehicle of claim 1, further comprising a label on the vehicle that indicates the vehicle includes one or more used powertrain components installed on a chassis constructed entirely of new materials, wherein the label comprises a machine-readable optical code, and wherein the optical code comprises one or more of an alpha-numeric sequence or a non-alpha-numeric symbol or set of symbols.

6. The upcycled vehicle of claim 1, further comprising a label on the vehicle that indicates the vehicle includes one or more used powertrain components installed on a chassis constructed entirely of new materials, wherein the label comprises a machine-readable optical code, wherein the optical code comprises one or more of an alpha-numeric sequence or a non-alpha-numeric symbol or set of symbols, and wherein the non-alpha-numeric symbol or set of symbols comprises a one-dimensional barcode, a two-dimensional barcode, a three-dimensional barcode, a color-code, or combinations thereof.

7. The upcycled vehicle of claim 1, further comprising a label on the vehicle that indicates the vehicle includes one or more used powertrain components installed on a chassis constructed entirely of new materials, wherein the label comprises a machine-readable optical code, wherein the optical code comprises a previously-titled vehicle year indicator, a previously-titled vehicle make indicator, a previously-titled vehicle model indicator, a previously-titled vehicle component indicator, or a combination thereof.

8. The upcycled vehicle of claim 1, wherein vehicle comprises a three-wheeled roadster.

9. The upcycled vehicle of claim 1, wherein the universal engine cradle comprises a front-engine cradle, a front-mid-engine cradle, a rear-mid-engine cradle, or a rear-engine cradle.

10. The upcycled vehicle of claim 1, wherein the vehicle comprises front-wheel drive, rear-wheel drive, three-wheel drive, four-wheel drive, or combinations thereof.

11. The upcycled vehicle of claim 1, wherein the powertrain comprises an internal combustion engine, an electric motor, or a hybrid internal combustion engine-electric motor.

12. The upcycled vehicle of claim 1, wherein the one or more used components comprise an engine block, a manifold, a camshaft, pistons, a cylinder head, a crankshaft, a starter motor, a valve cover, a transmission, a flywheel, a differential, a gearbox, a transfer case, a wiring harness, a computer, or combinations thereof.

13. The upcycled vehicle of claim 1, further comprising a lease document provided with the upcycled vehicle from a lessor to a lessee that grants use of the upcycled vehicle to the lessee.

14. The upcycled vehicle of claim 13, wherein the lease document describes an effective term of the lease, the term based on a period of time, a fixed number of miles, or a combination thereof.

15. The upcycled vehicle of claim 13, wherein the lease document describes an obligation on the lessor to provide a minimum amount of fuel for the upcycled vehicle during an effective term of the lease, a maximum amount of fuel for the upcycled vehicle during an effective term of the lease, or a combination thereof.

16. The upcycled vehicle of claim 13, wherein the lease document describes an obligation on the lessor to provide maintenance for the upcycled vehicle during an effective term of the lease.

17. The upcycled vehicle of claim 13, wherein the lease document describes an obligation on the lessor to provide insurance for the upcycled vehicle during an effective term of the lease.

18. The upcycled vehicle of claim 13, wherein the lease document describes permission granted to the lessee to sub-lease the upcycled vehicle during an effective term of the lease.

19. The upcycled vehicle of claim 13, further comprising an engine history document provided with the lease document or described in the lease document.

20. The upcycled vehicle of claim 1, further comprising a consumer-accessible database storing information about the upcycled vehicle, access to which is provided with the upcycled vehicle, the information comprising identifying characteristics of the engine, mileage of the engine, one or more reasons the engine was removed from the previously-titled vehicle, how the engine was selected, from where the engine was selected, repairs made to the engine before the installation, or a combination thereof.
